(19) United States
(12) Patent Application Publication
(10) Pub. No.: US 2018/0032552 A1
(43) Pub. Date: Feb. 1, 2018

(54) Configurable Hyper-Referenced Associative Object Schema

(71) Applicants: Jeremy Scheerer, Atlanta, GA (US); Garrett Shaw, Atlanta, GA (US); Parnell White, Atlanta, GA (US)

(72) Inventors: Jeremy Scheerer, Atlanta, GA (US); Garrett Shaw, Atlanta, GA (US); Parnell White, Atlanta, GA (US)

(73) Assignee: Georgia Tech Research Corporation, Atlanta, GA (US)

(21) Appl. No.: 15/661,959

(22) Filed: Jul. 27, 2017

Related U.S. Application Data
(60) Provisional application No. 62/369,511, filed on Aug. 1, 2016.

(51) Int. Cl. G06F 17/30

(52) U.S. Cl. CPC G06F 17/30294; G06F 17/30091; G06F 17/30321; G06F 17/30106

(57) ABSTRACT

In a method of managing at least two different data sets each structural and data element of each data set is associated with a unique identifier. Data model definitions for each data set are generated so that each data model definition sets forth a model for data in the data set. Data structure definitions for each data set are generated so that each data structure definition sets forth structural relationships between each data element within the data set. Function definitions are generated so that each function definition sets forth functions that can operate on data elements from both data sets. Model instances are listed for each model in each data set. Structure instances are listed for each instance of a data element in each data set. Function instances are listed for each instance of a function that operates on data elements in each data set.

### CROSS-REFERENCE TO RELATED APPLICATION(S)

This application claims the benefit of U.S. Provisional Patent Application Ser. No. 62/369,511, filed Aug. 1, 2016, the entirety of which is hereby incorporated herein by reference.

### BACKGROUND OF THE INVENTION

### 1. Field of the Invention

The present invention relates to database management systems and, more specifically, to a database management system for managing data from diverse data sources.

### 2. Description of the Related Art

A database is a collection of information that is stored in an organized manner and that facilitates quick access to the information. Most modern databases store information as digital data on computer-readable media. Users of such databases are able to perform a nearly limitless number of functions on the database, such as string searches, mathematical operations, accounting functions, etc.

There are many database formats that are chosen based on such things as the type of data being stored, the resources available and the preference of the database developer. One type of database is conceptualized as a simple table in which each record (or row of a table) contains a fixed number of fields. Each field is separated by a reserved character, such as a comma (which is used in comma separated value “CSV” files), and is populated with data from a predefined format. For example, the data could be binary data, character data or of any format selected by the developer. The first record can include headings that indicate the nature of the data that follows. For example, an employee file could include the following headings: “Last Name,” “First Name,” “Position,” “Employee Number,” etc.

A hierarchical database, on the other hand, organizes data fields according to a tree structure wherein each data field includes a pointer to the address of other fields to which it relates. For example, in a hierarchical employee database, the data field that stores “Employee Number” might include pointers to “Last Name,” “First Name” and “Position.”

Many users of databases have a need to access data from several databases of different types. Frequently the databases have a certain amount of overlap. For example, when accessing two different databases, the names of individuals can appear in both databases and can be stored in different formats (e.g., as “Last Name” in one and “Surname” in another).

In some cases, developers who want to consolidate multiple databases will translate all databases of interest into the format of a single database and store the results. In such situations one might not be able to perform all of the functions on a consolidated database that can be performed on the source databases. Also, the resulting consolidated database frequently does not preserve the structures of all of the source databases and, therefore, it can be extremely difficult to restore data from a consolidated database back to the source databases that were brought together to form the consolidated database.

Therefore, there is a need for a method of managing data from databases of different formats that preserves the functionality and structure of the source databases.

### SUMMARY OF THE INVENTION

The disadvantages of the prior art are overcome by the present invention which, in one aspect, is a method of managing at least two different data sets, in which data model definitions for each data set are generated so that each data model definition sets forth a model for data in the data set. Data structure definitions for each data set are generated so that each data structure definition sets forth structural relationships between each data element within the data set. Function definitions are generated so that each function definition sets forth functions that can operate on data elements from both data sets. Model instances are listed for each model in each data set. Structure instances are listed for each instance of a data element in each data set. Function instances are listed for each instance of a function that operates on data elements in each data set. Each data model definition is associated with each corresponding structure definition, each corresponding function definition and each corresponding model instance. Each structure definition is associated with each corresponding model definition, each corresponding function definition and each corresponding structure instance. Each function definition is associated with each corresponding model definition, each corresponding structure definition and each corresponding function instance. Each model instance is associated with each corresponding model definition, each corresponding function instance and each corresponding structure instance. Each structure instance is associated with each corresponding structure definition, each corresponding model instance and each corresponding function instance. Each function instance is associated with each corresponding function definition, each corresponding model instance and each corresponding structure instance. The data model definitions, the data structure definitions, the function definitions, the model instances, the structure instances are stored in a new file. A selected function is applied to at least one data value in the new file. Results of application of the selected function are returned.

In another aspect, the invention is a method, executed by a user, of managing data from a plurality of databases, including at least a first database of a first type and a second database of a second type that is different from the first type, in which at least one model definition corresponding to each of the plurality of databases is defined and a unique identifier (UID) is assigned to each model. A plurality of data structure definitions corresponding to each database is defined. Each data structure definition defines a structural relationship between data elements within the database. A UID is assigned to each of the plurality of data structure definitions. A UID is assigned to each data element in each database. A plurality of function definitions is generated. Each function definition sets forth a functional relationship between corresponding data elements from each database. A UID is assigned to each function definition. A UID is assigned to each instance one of the models being used. A UID is assigned to each instance of one of the plurality of functions being used. A plurality of ordered triples is generated. Each ordered triple includes: a first field that has a selected one of a UID or a data value; a second field that has a selected one of a UID or a data value; and a third field that indicates a relationship between the first field and the second field. The plurality of ordered triples including: a model definition set for each model that includes: (1) a model name ordered triple that associates a model name for the each model with the UID for the model; (2) a plurality of structure ordered triples that each associate the UID for the model definition with the UID for each of the first plurality of data structure definitions; (3) a plurality of model instance ordered triples that associate the UID for the model definition with the UID for each instance of the model in the first database; and (4) a plurality of function definition ordered triples that associate the UID for the model with the UID for each function definition. A structure definition set includes: (1) a plurality of structure name ordered triples that each associate a structure name for each one of the structure definitions with a UID for the function name; (2) a plurality of structure instance ordered triples that each associate the UID for at least one of the structure definitions with the UID for a data element that is part of structure definition; and (3) a plurality of function definition ordered triples that each associate the UID for at least one of the structure definitions with the UID for a function definition. A model instances set d for each model instance and includes: (1) at least one definition ordered triple that associates the UID of the model instance with a UID of a corresponding model definition; (2) a plurality of structure instances ordered triples that each associate the UID of the model instance with the UID of each data element associated with the model instance; and (3) a plurality of function instances ordered triples that each associate the UID of the model instance with a UID for a function that has been executed on data elements associated with the model instance. A structure instances set for each data element set includes: (1) a plurality of data value triples that associate a data value for each data element with the UID for the data element; (2) a plurality of model instance ordered triples that associate the UID for each model instance used with the data element with a UID for a data element; and (3) a plurality of structure definition ordered triples that associate the UID for a structure definition used with the data element with a UID for a data element. A function definitions set for each function definition and includes: (1) a function ordered triple that associates a function UID with a functional operation; (2) a model ordered triple that associates the UID for the function with the UID for the model to which the function applies; (3) a plurality of structure definition ordered triples that associate the function UID with the UID for each of the structure definitions for which the function is allowed to operate; and (4) a plurality of function instance ordered triples that associate the function UID with the UID for each instance in which the function is invoked. A function instances set for each function instance set that includes: (1) a plurality of input ordered triples than each associate the UID for the function instance with each UID of each data element operated on by the function instance; (2) a function ordered triple that associates the UID for the function instance with the UID for the function definition being employed in the function instance; (3) a model ordered triple that associates the UID for the function instance with the UID for the model to which the function applies; and (4) a return value ordered triple that associates the UID for the function instance with a return value that results from invocation of the function. All of the ordered triples are stored in a computer readable memory. Input is received from the user to associate a UID from the first database with a UID from the second database, thereby establishing a first database/second database association. The first database/second database association is used to access data elements from both the first database and the second database with a single searched data element.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram showing two different types of data sets.

FIG. 1B is a schematic diagram showing different arrangements for ordered triples.

FIG. 1C is a schematic diagram showing transformation of the data sets shown in FIG. 1A into ordered triples.

FIG. 1D is a schematic diagram showing a file of ordered triples that combines the data sets shown in FIG. 1A.

FIG. 2 is a schematic diagram showing relationships between definitions.

FIG. 3 is a schematic diagram showing relationships between instances.

FIG. 4 is a schematic diagram showing relationships between definitions and instances.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

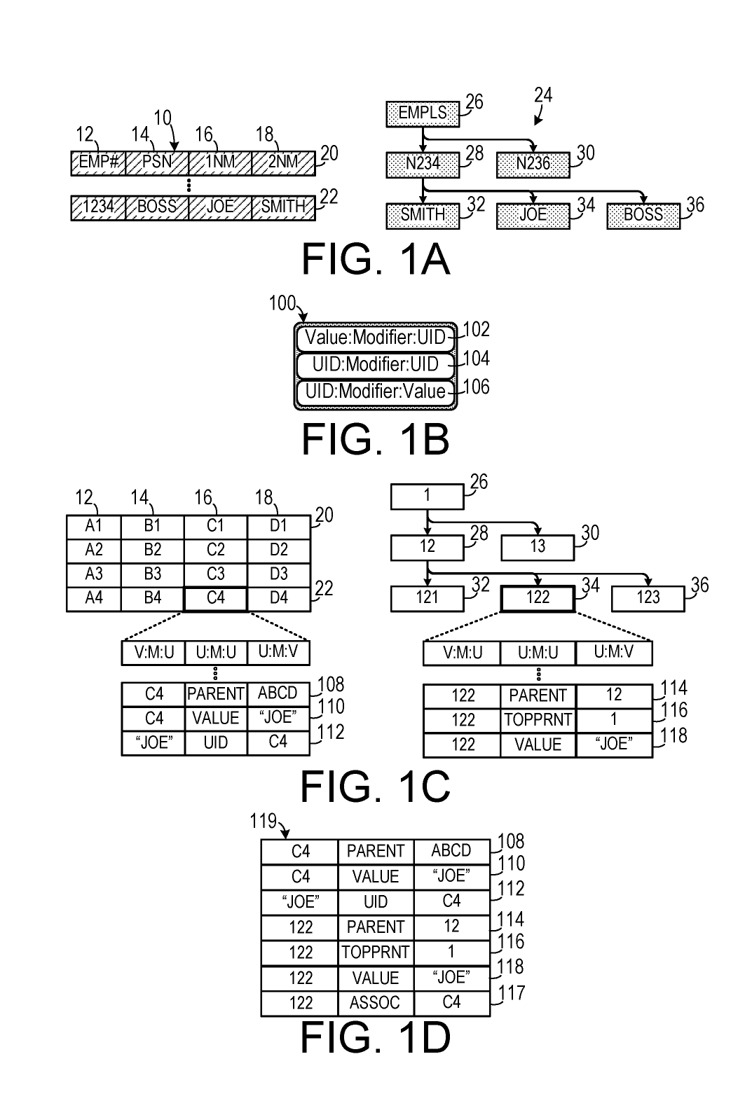

As shown in FIGS. 1A-1D, in a simple illustrative embodiment, the database management system can consolidate information from data sets of different types of source databases while preserving the information necessary to reconstruct the original data sets. The source datasets can include information organized in any matter. Several examples of source database types include: relational, hierarchical, ontological, and unstructured.

As shown, for example, in FIG. 1A, a first data set 10 can be a tabular data set in which data is organized into rows 20, 22 and columns 12, 14, 16, 18. In this example, row 20 can include descriptive headers (e.g., “Employee Number”; “Position”; “First Name”; and “Last Name”) and subsequent rows (e.g., row 22) can contain actual data that corresponds to the headers. In this example, a second data set 24 can be organized hierarchically according to a predesigned organizational structure, with a top-level field 26 that points to one or more second-level fields 28, 30, each of which may point to third level fields 32, 34, 36. In this example, the actually data in the fields in both data sets is the same; however, in other examples the data sets can contain different data, some of which might overlap.

The system employs a plurality of “ordered triples” 100—data units that each include three fields—to store the data and the structure of both data sets into a unified file. As shown in FIG. 1B, an ordered triple 100 can be of one of three formats, including: (1) a first format 102 in which the first field is a data value (e.g., string, number, etc.), a second field (which in the drawing and in the examples that follow is actually shown at the right end of the ordered triple) that includes a unique identifier (UID), and the third field (which is shown between the first field and the second field) that includes a modifier, such as a term that sets forth a relationship between the first field and the third field; (2) a second format 104 in which the first field is a UID that identifies a data unit or object, the second field is a UID of a data unit or object being pointed to and the third field sets forth the relationship between what the UID in the first filed identifies and what the UID in the second field identifies; and (3) a third format in which the first field is a UID for a data unit, the second field is a value for that data unit and the third field indicates that the UID is the UID for the value.

This is demonstrated in FIG. 1C in which several ordered triples are generated for the value in the third data field from row 22 of the tabular data set. The first ordered triple 108 indicates that this data field has been assigned UID C4 and is associated with parent model definition “ABCD.” The second ordered triple 110 indicates that UID C4 includes a data field with a value of “JOE” and the third ordered triple 112 indicates that the data value “JOE” is associated with UID C4. Similarly, for the hierarchical data set, the first ordered triple 114 shows that UID 122 is a child of a parent data field with UID 12. The next ordered triple 116 shows that UID 122 is associated with a top level data field that has been assigned UID 1 and the next ordered triple 118 indicates that UID 122 identifies a data field with a value of “JOE” in it.

A similar process is performed for every data unit and every structure within the data sets. All of the resulting ordered triples, a subset of which is shown in FIG. 1D, are then stored in a new data set 119. One function that can be performed on the resulting data set 119 is that associations between different UIDs can be made to allow access of the information from one of the original data sets when accessing data from another of the data sets. For example, the ordered triple 117 shows that the value identified by UID 122 corresponds to the value identified by UID C4. This association can be derived from user input or it can be derived by a computer using stored knowledge about the original data sets.

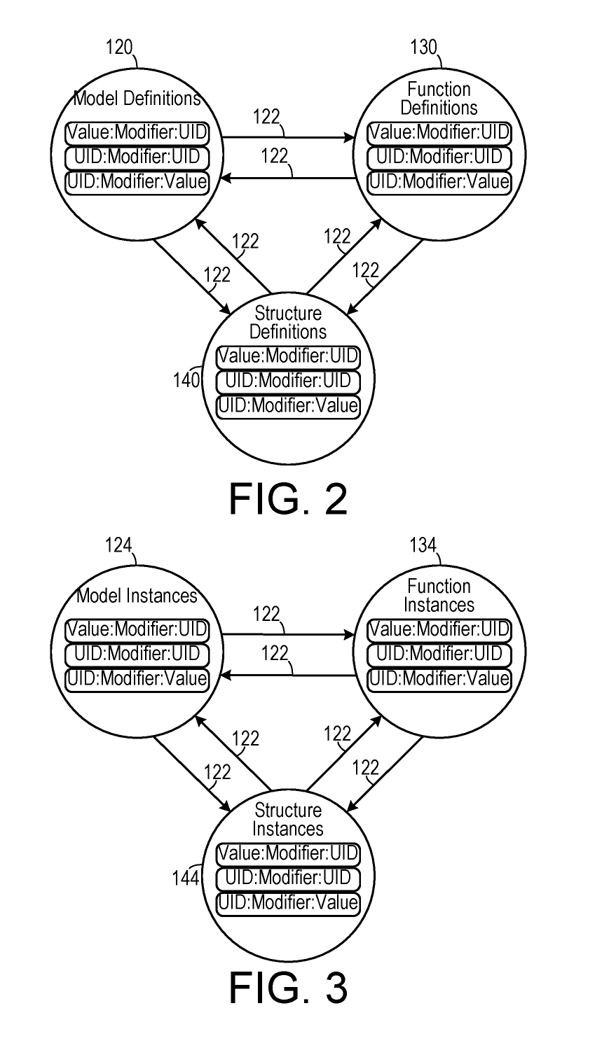

As shown in FIG. 2, the data sets can be described with: model definitions 120, which name a data model in the data set and list the structures employed in a model; structure definitions 140, which define the data structures by which the data values in the data set are organized; and function definitions 130, which define the functional operations that can be applied to the data values. Model definitions can be detected from a database when a database includes information about the model being used. For example, the first line in a database might say something like “EMPLOYEE LIST,” which would indicate that the information employs an employee list model. The model can also be determined by a lookup table that associates the file name of the data set (or other identifier) with a given model. In some cases, the user can examine the data to determine which model to apply or to construct a new model. Such constructed models can then be stored in a library of models for application to future data sets.

Each model definition 120 includes a UID-UID associating ordered triple 122 linking it to each function definition 130 with which it is associated and a UID-UID associating ordered triple 122 linking it to each structure definition 140 with which it is associated. Similarly, each function definition 130 includes a UID-UID associating ordered triple 122 linking it to each model definition 120 with which it is associated and a UID-UID associating ordered triple 122 linking it to each structure definition 140 with which it is associated. Similarly, each structure definition 140 includes a UID-UID associating ordered triple 122 linking it to each model definition 120 with which it is associated and a UID-UID associating ordered triple 122 linking it to each function definition 130 with which it is associated.

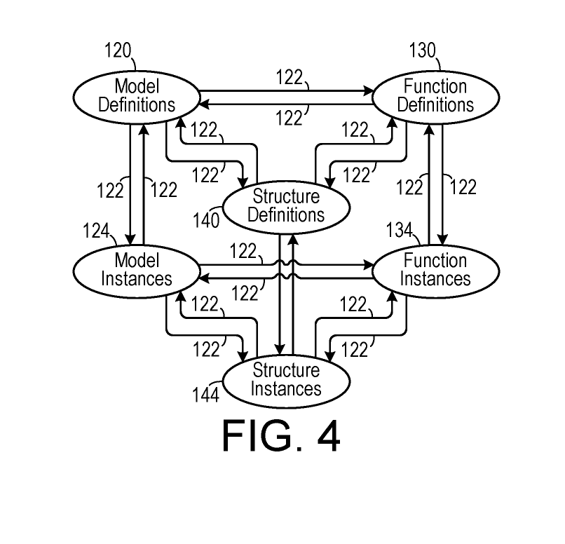

As shown in FIG. 3, the data in the data sets is organized according to: model instances 124, which list each instance of a model being applied to the data; function instances 134, which list each application of a function to the data; and structure instances 144, which list the data values from the data sets. Each model instance 124 includes a UID-UID associating ordered triple 122 linking it to each function instance 134 with which it is associated and a UID-UID associating ordered triple 122 linking it to each structure instance 144 with which it is associated. Similarly, each function instance 134 includes a UID-UID associating ordered triple 122 linking it to each model instance 124 with which it is associated and a UID-UID associating ordered triple 122 linking it to each structure instance 144 with which it is associated. Similarly, each structure instance 144 includes a UID-UID associating ordered triple 122 linking it to each model instance 124 with which it is associated and a UID-UID associating ordered triple 122 linking it to each function instance 134 with which it is associated. As shown in FIG. 4, each model definition 120 includes a UID-UID associating ordered triple 122 linking it to each model instance 124 with which it is associated; each function definition 130 includes a UID-UID associating ordered triple 122 linking it to each function instance 134 with which it is associated; and each structure definition 140 includes a UID-UID associating ordered triple 122 linking it to each structure instance 144 with which it is associated.

This method of data storage allows a user to perform functions on the data from all of the original data sets, such as searching, concatenating, form population, etc. The system allows the use to search and segregate data quickly by searching all relevant ordered triples and then retrieving data from associated ordered triples.

The following example demonstrates the system as applied to two data sets: the first a data table and second a hierarchal example based on an eXtensible Markup Language (XML) file. The data table based file in this example is an employee list that includes the following information about an employee: surname, given name, user identification, and position. The table can be visualized as follows:

| surname | given | userid | position |
|---|---|---|---|
| White | Parnell | pwhite8 | Research Engineer I |
| Shaw | Garrett | gshaw6 | Research Engineer II |
| Scheerer | Jeremy | jscheerer1 | Research Associate II |

The hierarchal data based file in this example can store information about the titles of papers published in a journal and the authors of the papers. As can be seen, some of the information in this data set is the same as information in the data table listed above.

This data set can be visualized as follows:

<document>

<author>pwhite8</author>
<title>Configurable Hyper-Referenced Associative Object Schema

(CHAOS)</title>

<editor>

<lastname>Shaw</lastname>
<firstname>Garrett</firstname>

</editor>
<editor>

<lastname>Scheerer</lastname>
<firstname>Jeremy</firstname>

</editor>
<editor>

<lastname>Hale</lastname>
<firstname>Chris</firstname>

</editor>
<text>Some text here</text>

</document>

The system breaks down both data sets an generates a series of ordered triples that describe the models, the instances of the models being used, the data structures and the instances of the data values being applied to the data structures.

Applying the system for the data table implementation results in the generation of the following ordered triples (each of the rows shown is an ordered triple):

Model Definition:

| | | |
|---|---|---|
| UID1 | modelname | surname\|given\|userid\|posi- |
| | | tion |
| UID1 | contains | UID2 |
| UID1 | contains | UID3 |
| UID1 | contains | UID4 |
| UID1 | contains | UID5 |
| UID1 | instance | UID6 |
| UID1 | instance | UID7 |
| UID1 | instance | UID8 |
| toplevelmodelname\| | uid | UID1 |
| surname\|given\|userid\|position | | |

Structure Definition:

| | | |
|---|---|---|
| UID2 | parent | UID1 |
| UID2 | topparent | UID1 |
| UID2 | value | surname |
| UID2 | instance | UID9 |
| UID2 | instance | UID10 |
| UID2 | instance | UID11 |
| UID3 | parent | UID1 |
| UID3 | topparent | UID1 |
| UID3 | value | given |
| UID3 | instance | UID12 |
| UID3 | instance | UID13 |
| UID3 | instance | UID14 |
| UID4 | parent | UID1 |
| UID4 | topparent | UID1 |
| UID4 | value | userid |
| UID4 | instance | UID15 |
| UID4 | instance | UID16 |
| UID4 | instance | UID17 |
| UID5 | parent | UID1 |
| UID5 | topparent | UID1 |
| UID5 | value | position |
| UID5 | instance | UID18 |
| UID5 | instance | UID19 |
| UID5 | instance | UID20 |
| structuredefname\|given | uid | UID3 |
| structuredefname\|position | uid | UID5 |
| structuredefname\|surname | uid | UID2 |
| structuredefname\|userid | uid | UID4 |

Model Instance:

| | | |
|---|---|---|
| UID6 | definition | UID1 |
| UID6 | contains | UID9 |
| UID6 | contains | UID12 |
| UID6 | contains | UID15 |
| UID6 | contains | UID18 |
| UID7 | definition | UID1 |
| UID7 | contains | UID10 |
| UID7 | contains | UID13 |
| UID7 | contains | UID16 |
| UID7 | contains | UID19 |
| UID8 | definition | UID1 |
| UID8 | contains | UID11 |
| UID8 | contains | UID14 |
| UID8 | contains | UID17 |
| UID8 | contains | UID20 |

Structure Instance:

| | | |
|---|---|---|
| UID9 | definition | UID2 |
| UID9 | parent | UID6 |
| UID9 | topparent | UID6 |
| UID9 | value | White |
| UID10 | definition | UID2 |
| UID10 | parent | UID7 |
| UID10 | topparent | UID7 |
| UID10 | value | Shaw |
| UID11 | definition | UID2 |
| UID11 | parent | UID8 |
| UID11 | topparent | UID8 |
| UID11 | value | Scheerer |
| UID12 | definition | UID3 |
| UID12 | parent | UID6 |
| UID12 | topparent | UID6 |
| UID12 | value | Parnell |
| UID13 | definition | UID3 |
| UID13 | parent | UID7 |
| UID13 | topparent | UID7 |
| UID13 | value | Garrett |
| UID14 | definition | UID3 |
| UID14 | parent | UID8 |
| UID14 | topparent | UID8 |
| UID14 | value | Jeremy |
| UID15 | definition | UID4 |
| UID15 | parent | UID6 |
| UID15 | topparent | UID6 |
| UID15 | value | pwhite8 |
| UID16 | definition | UID4 |
| UID16 | parent | UID7 |
| UID16 | topparent | UID7 |
| UID16 | value | gshaw6 |
| UID17 | definition | UID4 |
| UID17 | parent | UID8 |
| UID17 | topparent | UID8 |
| UID17 | value | jscheerer1 |
| UID18 | definition | UID5 |
| UID18 | parent | UID6 |
| UID18 | topparent | UID6 |
| UID18 | value | Research Engineer I |
| UID19 | definition | UID5 |
| UID19 | parent | UID7 |
| UID19 | topparent | UID7 |
| UID19 | value | Research Engineer II |
| UID20 | definition | UID5 |
| UID20 | parent | UID8 |
| UID20 | topparent | UID8 |
| UID20 | value | Research Associate II |
| stringinst\|Garrett | uid | UID13 |
| stringinst\|gshaw6 | uid | UID16 |
| stringinst\|Jeremy | uid | UID14 |
| stringinst\|jscheerer1 | uid | UID17 |
| stringinst\|Parnell | uid | UID12 |
| stringinst\|pwhite8 | uid | UID15 |
| stringinst\|Research Associate II | uid | UID20 |
| stringinst\|Research Engineer I | uid | UID18 |
| stringinst\|Research Engineer II | uid | UID19 |
| stringinst\|Scheerer | uid | UID11 |
| stringinst\|Shaw | uid | UID10 |
| stringinst\|White | uid | UID9 |

There are a couple of notable components in the hierarchal data that are different from the data table. The first is in the model instance where the top level model shows both the first level component it contains and the lower level children, noted as “containsdeep.” This allows the entire object to be pulled once the top level is reached. Applying the system for the hierarchal data implementation results in:

Model Definition:

| | | |
|---|---|---|
| UID101 | modelname | document |
| UID101 | contains | UID102 |
| UID101 | contains | UID103 |
| UID101 | contains | UID104 |
| UID101 | contains | UID105 |
| UID101 | instance | UID106 |
| UID104 | modelname | editor |
| UID104 | parent | UID101 |
| UID104 | topparent | UID101 |
| UID104 | contains | UID107 |
| UID104 | contains | UID108 |
| UID104 | instance | UID109 |
| UID104 | instance | UID110 |
| UID104 | instance | UID111 |
| modelname\|editor | uidUID104 | |
| toplevelmodelname\|document | uid | UID101 |

Structure Definition:

| | | |
|---|---|---|
| UID102 | parent | UID101 |
| UID102 | topparent | UID101 |
| UID102 | value | author |
| UID102 | instance | UID112 |
| UID103 | parent | UID101 |
| UID103 | topparent | UID101 |
| UID103 | value | title |
| UID103 | instance | UID113 |
| UID105 | parent | UID101 |
| UID105 | topparent | UID101 |
| UID105 | value | text |
| UID105 | instance | UID114 |
| UID107 | parent | UID104 |
| UID107 | topparent | UID101 |
| UID107 | value | lastname |
| UID107 | instance | UID115 |
| UID107 | instance | UID116 |
| UID107 | instance | UID117 |
| UID108 | parent | UID104 |
| UID108 | topparent | UID101 |
| UID108 | value | firstname |
| UID108 | instance | UID118 |
| UID108 | instance | UID119 |
| UID108 | instance | UID120 |

Model Instance:

| | | |
|---|---|---|
| UID106 | definition | UID101 |
| UID106 | contains | UID109 |
| UID106 | contains | UID110 |
| UID106 | contains | UID111 |
| UID106 | contains | UID112 |
| UID106 | contains | UID113 |
| UID106 | contains | UID114 |
| UID106 | containsdeep | UID115 |
| UID106 | containsdeep | UID116 |
| UID106 | containsdeep | UID117 |
| UID106 | containsdeep | UID118 |
| UID106 | containsdeep | UID119 |
| UID106 | containsdeep | UID120 |
| UID109 | parent | UID106 |
| UID109 | topparent | UID106 |
| UID109 | definition | UID104 |
| UID109 | contains | UID115 |
| UID109 | contains | UID118 |
| UID110 | parent | UID106 |
| UID110 | topparent | UID106 |
| UID110 | definition | UID104 |
| UID110 | contains | UID116 |
| UID110 | contains | UID119 |
| UID111 | parent | UID106 |
| UID111 | topparent | UID106 |
| UID111 | definition | UID104 |
| UID111 | contains | UID117 |
| UID111 | contains | UID120 |

Structure Instance:

| | | |
|---|---|---|
| UID112 | definition | UID102 |
| UID112 | value | pwhite8 |
| UID112 | parent | UID106 |
| UID112 | topparent | UID106 |
| UID113 | definition | UID103 |
| UID113 | value | Configurable Hyper- |
| | | Referenced Associative |
| | | Object Schema (CHAOS) |
| UID113 | parent | UID106 |
| UID113 | topparent | UID106 |
| UID114 | definition | UID105 |
| UID114 | value | Some text here |
| UID114 | parent | UID106 |
| UID114 | topparent | UID106 |
| UID115 | definition | UID107 |
| UID115 | value | Shaw |
| UID115 | parent | UID109 |
| UID115 | topparent | UID106 |
| UID116 | definition | UID108 |
| UID116 | value | Garrett |
| UID116 | parent | UID109 |
| UID116 | topparent | UID106 |
| UID117 | definition | UID107 |
| UID117 | value | Scheerer |
| UID117 | parent | UID110 |
| UID117 | topparent | UID106 |
| UID118 | definition | UID108 |
| UID118 | value | Jeremy |
| UID118 | parent | UID110 |
| UID118 | topparent | UID106 |
| UID119 | definition | UID107 |
| UID119 | value | Hale |
| UID119 | parent | UID111 |
| UID119 | topparent | UID106 |
| UID120 | definition | UID108 |
| UID120 | value | Chris |
| UID120 | parent | UID111 |
| UID120 | topparent | UID106 |
| stringinst\|Chris | uid | UID119 |
| stringinst\| Configurable | uid | UID113 |
| Hyper-Referenced Associative | | |
| Object Schema (CHAOS) | | |
| stringinst\|Garrett | uid | UID116 |
| stringinst\|Hale | uid | UID119 |
| stringinst\|Jeremy | uid | UID118 |
| stringinst\|pwhite8 | uid | UID112 |
| stringinst\|Scheerer | uid | UID117 |
| stringinst\|Shaw | uid | UID115 |
| stringinst\|Some text here | uid | UID114 |
| stringkey\|associative | uid | UID113 |
| stringkey\|chaos | uid | UID113 |
| stringkey\|configurable | uid | UID113 |
| stringkey\|hyper | uid | UID113 |
| stringkey\|object | uid | UID113 |
| stringkey\|referenced | uid | UID113 |
| stringkey\|schema | uid | UID113 |

When functions are applied to the data, the system employs a function definition and function instances.

Function Definition:

| | | |
|---|---|---|
| UID201 | value | return a == b |
| UID201 | varcombo1 | UID2 |
| UID201 | varcombo1 | UID107 |
| UID201 | varcombo2 | UID3 |
| UID201 | varcombo2 | UID108 |
| UID201 | instance | UID202 |

Certain additions may need to be made to the structure definitions when employing functions, for example:

| | | |
|---|---|---|
| UID2 | inputtofunction | UID201 |
| UID3 | inputtofunction | UID201 |
| UID107 | inputtofunction | UID201 |
| UID108 | inputtofunction | UID201 |
| UID115 | inputtofunction | UID202 |
| UID10 | inputtofunction | UID202 |

Example Function Instance:

| | | |
|---|---|---|
| UID202 | input | UID115 |
| UID202 | input | UID10 |
| UID202 | definition | UID201 |
| UID202 | returnvalue | true |
| functionreturn\|true | uid | UID202 |

In this example, the function determines whether the data value held in the structure definition UID2 is the same as the data value held in the structure definition UID107 (e.g. return a==b), as shown in the function definition. In the specific instance of this function being applied to this data, the “Shaw” value associated with UID115 was compared to the “Shaw” value associated with UID10 employing the function definition associated with UID 201 and the returned value associated with the function instance associated with UID 202 was “true.”

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of managing at least two different data sets, comprising the steps of:
(a) generating data model definitions for each data set, each data model definition setting forth a model for data in the data set;
(b) generating data structure definitions for each data set, each data structure definition setting forth structural relationships between each data element within the data set;
(c) generating function definitions, each function definition setting forth functions that can operate on data elements from both data sets;
(d) listing model instances for each model in each data set;
(e) listing structure instances for each instance of a data element in each data set;
listing function instances for each instance of a function that operates on data elements in each data set;
(g) associating each data model definition with each corresponding structure definition, each corresponding function definition and each corresponding model instance;
(h) associating each structure definition with each corresponding model definition, each corresponding function definition and each corresponding structure instance;
(i) associating each function definition with each corresponding model definition, each corresponding structure definition and each corresponding function instance;
(j) associating each model instance with each corresponding model definition, each corresponding function instance and each corresponding structure instance;
(k) associating each structure instance with each corresponding structure definition, each corresponding model instance and each corresponding function instance;
(l) associating each function instance with each corresponding function definition, each corresponding model instance and each corresponding structure instance;
(m) storing the data model definitions, the data structure definitions, the function definitions, the model instances, the structure instances in a new file;
(n) applying a selected function to at least one data value in the new file; and
(o) returning results of application of the selected function.

2. The method of claim 1, further comprising the step of storing function instances in the new file.

3. The method of claim 1, further comprising the steps of:
(a) assigning a unique identifier (UID) to each data element of each data set; and
(b) assigning a UID to each relationship between data elements in each data set.

4. The method of claim 3, further comprising the step of generating, for each structure instance an ordered triple that has three fields, including: a first field that includes one of the UID for the data element or a value of the data element; a second field that includes one of the UID for a data element, a UID for another data element, a UID for a model instance, a UID for a structure definition, a UID for a function instance, or a value of the data element; and a third field that sets forth a relationship between the first field and the second field.

5. The method of claim 3, further comprising the step of generating for each data model definition an ordered triple that has three fields, including: a first field that includes a selected one of the UID for the data model or a name for the data model; a second field that includes a selected one of a UID for a structural definition corresponding to the data model, a UID for a model instance employing the data model, the UID of the data model when the first field contains the name of the data model or the name of the data model; and a third field that sets forth a relationship between the first field and the second field.

6. The method of claim 3, further comprising the step of generating for each structure definition an ordered triple that has three fields, including: a first field that includes a selected one of a UID for the structure definition or a name for the structure definition; a second field that includes a selected one if a UID for a structure instance employing the structure definition or a value for the structure definition; and a third field that sets forth a relationship between the first field and the second field.

7. The method of claim 3, further comprising the step of generating for each function definition an ordered triple that has three fields, including: a first field that includes a UID for the function definition; a second field that includes a selected one of a function to be invoked or a UID for a structure definition on which the function may be performed; and a third field that sets forth a relationship between the first field and the second field.

8. The method of claim 3, further comprising the step of generating for each model instance an ordered triple that has three fields, including: a first field that includes a UID for the model instance; a second field that includes a selected one of a UID for a model definition, a UID for another model instance and a UID for a structure instance falling within the model; and a third field that sets forth a relationship between the first field and the second field.

9. The method of claim 3, further comprising the step of generating for each function instance an ordered triple that has three fields, including: a first field including a UID for the function instance; a second field that includes a selected one of a UID for a structure instance on which the function was performed, a UID for the function definition employed, and a value resulting from execution of the function; and a third field that sets forth a relationship between the first field and the second field.

10. The method of claim 1, further comprising the steps of:
(a) receiving user input indicating that a first data element from a first of the data sets is related to a second data element from a second of the data sets; and
(b) storing an association between the first data element and the second data element.

11. The method of claim 10, further comprising the step of accessing data in the second data set that is associated with data from the first data set.

12. The method of claim 1, further comprising the step of storing data from each data set in a file of ordered triples in which each ordered triple includes a first field including UID for each component of each data set, a second field including a selected one of a UID for another component of each data set or a data value, and a third field setting forth a relationship between the first field and the second field.

13. The method of claim 12, further comprising the step of storing each ordered triple in a new file.

14. The method of claim 1, further comprising the steps of:
(a) searching selected ones of the first fields of the ordered triples for a preselected data value; and
(b) retrieving data values pointed to by the third fields of ordered triples returned as a result of searching the first fields.

15. A method, executed by a user, of managing data from a plurality of databases, including at least a first database of a first type and a second database of a second type that is different from the first type, comprising the steps of:
(a) defining at least one model definition corresponding to each of the plurality of databases and assigning a unique identifier (UID) to each model;
(b) defining a plurality of data structure definitions corresponding to each database, wherein each data structure definition defines a structural relationship between data elements within the database, and assigning a UID to each of the plurality of data structure definitions;
(c) assigning a UID to each data element in each database;
(d) generating a plurality of function definitions, wherein each function definition sets forth a functional relationship between corresponding data elements from each database and assigning a UID to each function definition;
(e) assigning a UID to each instance one of the models being used;
(f) assigning a UID to each instance of one of the plurality of functions being used;
(g) generating a plurality of ordered triples, wherein each ordered triple includes: a first field that has a selected one of a UID or a data value; a second field that has a selected one of a UID or a data value; and a third field that indicates a relationship between the first field and the second field, the plurality of ordered triples including:
(i) a model definition set for each model that includes:
(1) a model name ordered triple that associates a model name for the each model with the UID for the model;
(2) a plurality of structure ordered triples that each associate the UID for the model definition with the UID for each of the first plurality of data structure definitions;
(3) a plurality of model instance ordered triples that associate the UID for the model definition with the UID for each instance of the model in the first database; and
(4) a plurality of function definition ordered triples that associate the UID for the model with the UID for each function definition;
(ii) a structure definition set that includes:
(1) a plurality of structure name ordered triples that each associate a structure name for each one of the structure definitions with a UID for the function name;
(2) a plurality of structure instance ordered triples that each associate the UID for at least one of the structure definitions with the UID for a data element that is part of structure definition; and
(3) a plurality of function definition ordered triples that each associate the UID for at least one of the structure definitions with the UID for a function definition;
(iii) a model instances set for each model instance that includes:
(1) at least one definition ordered triple that associates the UID of the model instance with a UID of a corresponding model definition;
(2) a plurality of structure instances ordered triples that each associate the UID of the model instance with the UID of each data element associated with the model instance; and
(3) a plurality of function instances ordered triples that each associate the UID of the model instance with a UID for a function that has been executed on data elements associated with the model instance;
(iv) a structure instances set for each data element set that includes:
(1) a plurality of data value triples that associate a data value for each data element with the UID for the data element;
(2) a plurality of model instance ordered triples that associate the UID for each model instance used with the data element with a UID for a data element; and
(3) a plurality of structure definition ordered triples that associate the UID for a structure definition used with the data element with a UID for a data element;
(v) a function definitions set for each function definition that includes:
(1) a function ordered triple that associates a function UID with a functional operation;
(2) a model ordered triple that associates the UID for the function with the UID for the model to which the function applies;
(3) a plurality of structure definition ordered triples that associate the function UID with the UID for each of the structure definitions for which the function is allowed to operate; and
(4) a plurality of function instance ordered triples that associate the function UID with the UID for each instance in which the function is invoked;
(vi) a function instances set for each function instance set that includes:
(1) a plurality of input ordered triples than each associate the UID for the function instance with each UID of each data element operated on by the function instance;
(2) a function ordered triple that associates the UID for the function instance with the UID for the function definition being employed in the function instance;
(3) a model ordered triple that associates the UID for the function instance with the UID for the model to which the function applies; and
(4) a return value ordered triple that associates the UID for the function instance with a return value that results from invocation of the function;
(h) storing all of the ordered triples in a computer readable memory;
(i) receiving input from the user to associate a UID from the first database with a UID from the second database, thereby establishing a first database/second database association; and
(j) using the first database/second database association to access data elements from both the first database and the second database with a single searched data element.

16. The method of claim 15, wherein the step of defining at least one model definition comprises the step of detecting the model definition from within the database.

17. The method of claim 15, wherein the step of defining at least one model definition comprises step of comparing data within the database to a library of model definitions and selecting a model definition from the library of definitions.

18. The method of claim 17, wherein when a new model definition is input into the system, storing the new model definition in the library of definitions.

19. The method of claim 15, wherein the step of defining at least one model definition comprises step of receiving model input from the user in which the input sets for the model definition.

20. The method of claim 19, further comprising the step of storing the model input from the user in the library of definitions.
